(19) United States
(12) Patent Application Publication
(10) Pub. No.: US 2026/0255268 A1
(43) Pub. Date: Aug. 27, 2026

(54) NETWORK ENERGY SAVING BASED ON ASSISTED INFORMATION FROM IDLE/INACTIVE UEN

(71) Applicant: Apple Inc., Cupertino, CA (US)

(72) Inventors: Peng Cheng, Beijing (CN); Ping-Heng Kuo, London (GB); Yuqin Chen, Beijing (CN); Haijing Hu, Los Gatos, CA (US); Fangli Xu, Beijing (CN); Naveen Kumar R Palle Venkata; Alexander Sirotkin, Hod Hasharon (IL); Ralf Rossbach, Munich (DE)

(21) Appl. No.: 18/877,343

(22) PCT Filed: Jun. 23, 2023
(86) PCT No.: PCT/US2023/026067

§ 371 Date: Dec. 20, 2024

Related U.S. Application Data
(60) Provisional application No. 63/391,437, filed on Jul. 22, 2022.

(51) Int. Cl. H04W 52/02; H04W 76/27

(52) U.S. Cl. CPC H04W 52/0235; H04W 76/27

(57) ABSTRACT

Techniques, described herein, include solutions for saving network energy using assistance information from a user equipment (UE) in an RRC idle or RRC inactive state. During operation, a base station may transmit synchronization signal/physical broadcast channel blocks (SSBs) to a UE. The UE may perform measurement on the SSBs and send assistance information to the base station based on the measurement performed on the SSBs. Based on the assistance information, the base station may adapt the transmission of the SSBs. The adaptation may be made based on the needs of the UE and the network. The network may save energy by only using aggressive (i.e. high energy consuming) transmission when needed. Adaptation of SSB transmission may include changing the periodicity of SSB transmission or changing the SSB beamforming (e.g. SSB beam width and number of beams).

### REFERENCE TO RELATED APPLICATIONS

This Application claims the benefit of U.S. Provisional Application No. 63/293,867, filed on Jul. 22, 2022, the contents of which are hereby incorporated by reference in their entirety

### FIELD

This disclosure relates to wireless communication networks including techniques for conserving power within wireless communication networks.

### BACKGROUND

Wireless communication networks may include user equipment (UEs), base stations, and/or other types of wireless devices capable of communicating with one another. During operation, a UE may measure signal quality of a serving cell and/or its neighboring cells periodically or triggered by certain condition. The UE measurements may be used to determine whether some procedures, such as handover to another cell or addition of another carrier component, are needed to improve the quality of a signal connection or to increase a bit rate.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a block diagram illustrating a wireless network including a user equipment (UE) and a base station for adapting synchronization signal/physical broadcast channel block (SSB) transmission based on assistance information from idle/inactive UE.

FIG. 2 is a schematic diagram illustrating signaling between a UE and a base station for adapting synchronization signal/physical broadcast channel block (SSB) transmission based on assistance information.

FIG. 3 is a schematic diagram illustrating signaling between a UE and a base station for adapting synchronization signal/physical broadcast channel block (SSB) transmission based on assistance information.

FIG. 4 is a flow diagram depicting a method for reporting assistance information.

FIG. 5 illustrates a logic flow for a UE configured to report assistance information.

FIG. 6 illustrates a logic flow for a UE configured to report assistance information.

FIG. 7 illustrates a logic flow for a UE configured to report assistance information.

FIG. 8 is a flow diagram depicting a method for reporting assistance information.

FIG. 9 is a block diagram illustrating a device that can be employed in accordance with some aspects of the present disclosure.

FIG. 10 is a block diagram illustrating baseband circuitry that can be employed in accordance with some aspects of the present disclosure.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

During operation, a user equipment (UE) needs to perform various measurements on reference signals to assess channel and signal quality of a serving cell and/or its neighboring cells. Such measurements may include reference signal received power (RSRP) measurement, reference signal received quality (RSRQ) measurement, signal to interference & noise ratio (SINR) measurements, or the like. Introduced in 5G, synchronization signal/physical broadcast channel (SS/PBCH) blocks (SSBs) may be used as such a reference signal for the UE measurements. Multiple SSBs are included in an SSB burst to address the requirements of beamforming and beam sweeping. Each SSB of the SSB burst is allocated to a beam, so each beam transmits its SSB with different allocated time resources. The SSB burst may be transmitted repeatedly from a base station to the UE within a time window that is scheduled periodically. Periodicity and duration of the time window are both defined by a SSB measurement timing configuration (SMTC).

One aspect of the continuing optimization to a wireless network is to reduce energy consumption of the network to achieve more efficient operation. Energy consumption can depend on many factors, including pattern, length, periodicity, and strength of the transmitted reference signals. For example, more frequent SSB transmission will result in higher power consumption. Depending on the type of beamforming used for the SSBs, energy consumption will also vary. For example, using a larger number of narrow beams will result in higher energy consumption.

Accordingly, the present disclosure relates to techniques to determine an SSB pattern based on assistance information reported by a UE in idle or inactive state, in order to achieve optimal network energy saving. In some aspects, a UE may be configured to perform measurements while in a RRC inactive or RRC idle mode. The UE may further be configured to generate assistance information based on the performed measurement and report the assistance information to a base station. The base station can then dynamically adapt a pattern of its SSB transmission based on the received assistance information. For example, the base station may initially transmit SSB with a long periodicity and a smaller number of wide beams to not consume excessive energy. This initial SSB pattern may meet needs of empty or low loads. However, when a more demanding service arrives, such as ultra-reliable low latency communications (URLLC) that is latency sensitive, a different SSB pattern may be desired. The assistance information can indicate such a need from the UE. Depending on the assistance information received from the UE, the network may modify the SSB pattern, such as SSB periodicity or number of SSB beams to meet more rigorous measurement needs. Thereby, energy consumption of the network transmission can be more accurately controlled and reduced compared to using a static or more coarsely adjusted SSB pattern.

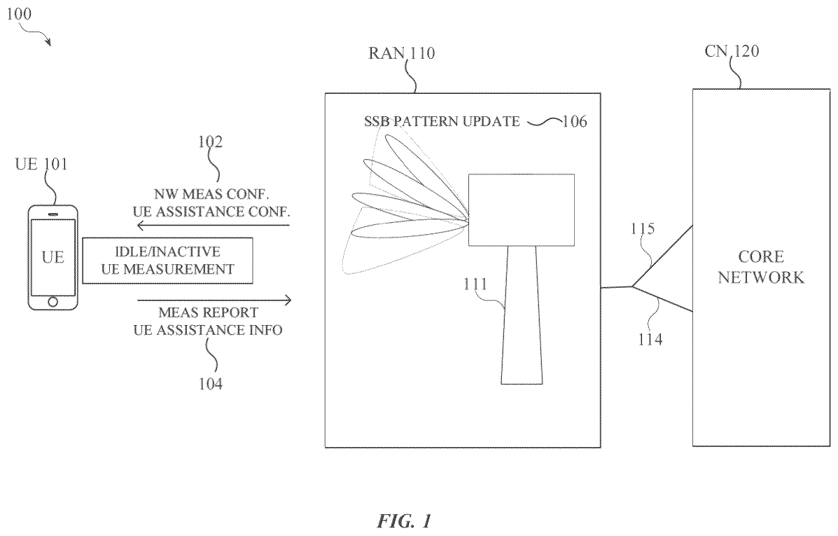

FIG. 1 illustrates an example architecture of a network system 100 in accordance with various aspects. The network system 100 includes a UE 101. In this example, the UE 101 is illustrated as a smartphone (e.g., a handheld touchscreen mobile computing device connectable to one or more cellular networks), but can comprise any mobile or non-mobile computing device, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, Machine Type Communication (MTC) devices, Machine to Machine (M2M), Internet of Things (IoT) devices, and/or the like.

The UE 101 can be configured to connect, for example, communicatively couple, with a Radio Access Network (RAN) 110. The RAN 110 may comprise one or more base stations 111. In some aspects, the RAN 110 can be a next generation (NG) RAN or a 5G RAN, an evolved-UMTS Terrestrial RAN (E-UTRAN), or a legacy RAN, such as a UTRAN or GERAN. As used herein, the term “NG RAN” or the like can refer to a RAN 110 that operates in an NR or 5G system, and the term “E-UTRAN” or the like can refer to a RAN 110 that operates in an LTE or 4G system.

The UE 101 may utilize connections (or channels) 102 and 104 comprising a physical communications interface/layer for downlink and uplink respectively. The base station 111 may utilize downlink connection 102 to transmit a measurement configuration. The measurement configuration may be included in the RRC message. The measurement configuration may configure the UE 101 to receive a reference signal from the base station 111 and perform configured measurements on the received reference signal. The UE 101 may provide measurement report to the base station 111 utilizing uplink connection 104.

In some aspects, the base station 111 transmits an RRC message (e.g. RRC release) to terminate or suspend an RRC connected state of the UE 101, which may cause the UE 101 to enter an RRC inactive or RRC idle state. The base station 111 may transmit a UE assistance configuration to the UE 101 in this RRC message. In some other aspects, the base station 111 may transmit the UE assistance configuration to the UE 101 through a broadcast signal such as a system information block (SIB). The UE assistance configuration may be used to configure the UE to report assistance information to the base station 111 while in an idle/inactive state.

While the UE 101 is in the idle/inactive state, the UE 101 may still receive SSB from the base station 111. The SSBs may be transmitted with a first pattern. The pattern of the SSBs may include a number of SSB beams, a width of the SSB beams, a periodicity of the SSB transmission, and so on. The UE 101 may perform a measurement on the SSBs based on the measurement configuration and report the measurement based on the UE assistance configuration. The measurement may include measuring RSRP, RSRQ, or SINR of the cell and/or individual SSB beams.

In some aspects, the UE 101 may report assistance information to the base station 111 utilizing uplink connection 104. The assistance information reported by the UE 101 may include a result of the measurement. As will be discussed in more details below, the UE 101 may be configured via the UE assistance configuration to report assistance information periodically or when a certain condition is satisfied.

In some aspects, based on the assistance information received, the base station 111 may perform an SSB pattern update 106. Depending on the needs of the UE 101, the base station may adapt its transmission of SSBs to be more aggressive, if a low latency or otherwise more demanding service is needed. Performing the SSB pattern update may include changing the SSB number of beams, width of the SSB beams, and/or periodicity of the SSB transmission.

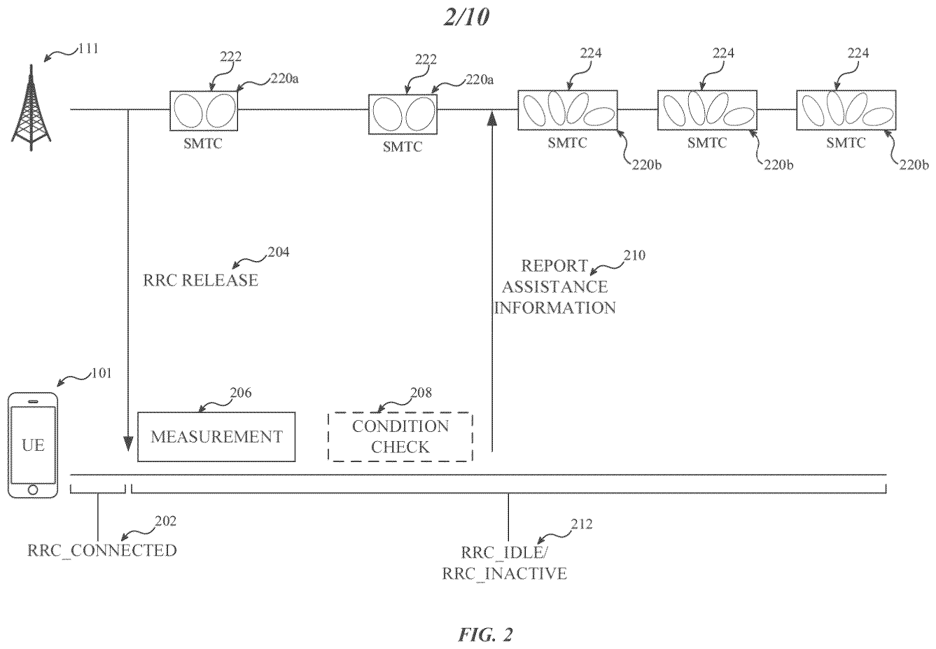

FIG. 2 is a schematic diagram illustrating a procedure where a base station 111 adapts its transmission of SSBs based on an assistance information received from a UE 101 while in a RRC inactive or RRC idle state in accordance with some aspects.

Initially, the UE 101 is in an RRC connected state at 202. In some aspects, while in the RRC connected state, the UE may exchange capability and preference information with the base station 111. The UE 101 may receive a UE capability enquiry message from the base station 111 and respond with UE capability information. The UE capability information, for example, can include a UE capability to report assistance information while in RRC idle/inactive. As an example, the UE capability to report assistance information could be a single bit indicating whether the UE 101 can report or not while in RRC idle/inactive. In one aspect, the UE capability to report could be a group of bits, each bit indicating a UE capability to report specific reporting contents (e.g. a bit for capability to report SSB measurement, a bit for capability to report mobility status, etc.).

In some aspects, the UE 101 may send UE assistance information (UAI) to the base station 111 while in the RRC connected state. The UAI may include preference information, and the preference information may specify a UE preference to report while in RRC idle/inactive. The UE preference to report may include information such as if the UE is willing to report while in RRC idle/inactive based on, for example, the UE's conditions such as battery level and how long the UE 101 is willing to report.

The UE 101 then receives an RRC release message 204 from the base station 111, causing the UE 101 to transition into an RRC inactive or RRC idle state at 212. In some aspects, the RRC release message 204 may cause the UE 101 to transition into the RRC idle state. For example, this could occur if the UE 101 is expected to not need to transfer data for a long duration. By transitioning into an RRC idle state, the UE 101 may reduce the amount of Tx/Rx signaling, and may conserve energy. In other aspects, the RRC release message 204 may cause the UE 101 to transition into the RRC inactive state. Similar to RRC idle, the UE 101 may save power by reducing the amount of signaling. The RRC release message 204 may cause the UE 101 to transition to the RRC inactive state if the UE 101 is expected to need to return to the RRC connected state soon. The UE 101 may transition from RRC inactive to RRC connected with minimal latency.

In some aspects, the RRC release message 204 may include a UE assistance configuration used to configure the UE 101 to report assistance information. The configuration could be initial configuration (e.g. if the UE 101 has not been previously configured) or reconfiguration (e.g. if the UE 101 received previous UE assistance configuration while in the RRC connected state). The UE assistance configuration may be based on the UE capability information and preference information.

During the RRC inactive or RRC idle state at 212, the UE 101 may perform measurements at 206 using reference signal(s) to prepare for cell selection or reselection. The measurements may include measuring RSRP, RSRQ, or SINR of the cells and/or individual beams. In some aspects, the measurement can be performed on SSB beams 222 within a first SMTC window 220a with a first SSB pattern, for example. In some aspects, the measurement is configured by a measurement configuration. For example, the measurement configuration may specify one or more measurement types. The measurement configuration may be transmitted from the base station 111 to the UE 101 in a RRC message during the RRC connected state at 202. The measurement configuration may alternatively and additionally be included in the RRC release message 204.

In some aspects, the UE 101 may be configured to perform conditional reporting. The UE may perform a condition check at 208 to determine if it should report assistance information to the base station 111 based on the UE assistance configuration and result of the measurements 206. As discussed above, the UE assistance configuration may be included in RRC signaling during the RRC connected state. Alternatively or additionally, in some aspects, the UE assistance configuration may be included in the RRC release message 204 and/or a broadcast signal such as a system information block (SIB). The condition check 208 may include comparing a value of the performed configured measurements 206 to a threshold value. In one aspect, the condition may be met if the value is greater than the threshold value. In another aspect, the condition is met if the value is less than the threshold value.

In some aspects, the UE assistance configuration may specify how long the UE 101 shall report. For example, if the UE assistance configuration specifies a reporting duration of N minutes. The UE 101 would enter RRC idle or RRC inactive and report for N minutes before ceasing reporting. The condition check 208 may further include checking if this reporting duration is exceeded. For example, checking if the reporting duration is exceeded could be implemented by starting a timer when the UE 101 enters RRC idle/inactive and checking if the timer has expired at the condition check 208. Checking if the timer is expired could include checking if the timer is less than a threshold value (e.g. for a timer counting up) or checking if the timer is still running (e.g. for a timer counting down). After the timer is expired, the UE 101 may cease reporting of assistance information to the base station 111.

In some aspects, the UE 101 is scheduled to report assistance information to the base station 111 at 210. The assistance information reporting may be scheduled based on a result of the condition check 208. In some aspects, the UE 101 reports the assistance information if the measurement value is greater than the threshold value. In other examples, the UE 101 reports the assistance information if the measurement value is less than the threshold value.

In some additional aspects, the UE 101 reports the assistance information periodically according to a timer. The timer may be configured, for example, by RRC Release message 204. The UE 101 may report the assistance information at 210 every time the timer expires. After each reporting occasion, the timer may be reset and the process may be repeated. In this example, the UE 101 skips the condition check 208.

In some aspects, the condition check 208 may fail (and the UE 101 does not report the assistance information at 210) if the UE 101 is reporting too frequently. This may be accomplished by using a prohibit timer. The prohibit timer could specify a minimum time between each reporting occasion (e.g. time between an initial assistance information report and the next assistance information report). For example, a prohibit timer may start on an occasion where the UE 101 reports the assistance information at 210. The UE 101 may not report the assistance information again until the prohibit timer expires. Once the UE 101 reports the assistance information again at 210, then the prohibit timer may be reset and the UE 101 may wait and not report the assistance information until the prohibit timer expires again.

In some further additional aspects, the UE 101 reports the assistance information in response to a paging message. The paging message, for example, could be a paging record, group paging message, or short message. The paging record may include a paging cause, indicating that the paging message is a request for assistance information. The group paging message may be an early paging indication (EPI) message. The short message may be, for example, a short message in downlink control information (DCI) 1-0.

In some aspects, the UE 101 may need to continue to measure and report in a neighbor cell while in RRC idle/inactive. The UE 101 may receive an additional UE assistance configuration to further configure and/or reconfigure the UE 101 to perform measurement/reporting in the neighbor cell. The additional UE assistance configuration may be indicated in SIB. Additionally, an indication on whether the neighbor cell supports receiving assistance information when the UE 101 is in idle/inactive state may also be included in SIB. If the neighbor cell supports receiving the assistance information from the UE 101 when in RRC idle/inactive, then the UE 101 may continue to measure/report based on the additional UE assistance configuration.

The assistance information may be transmitted by the UE 101 to the base station 111 in several ways.

In some aspects, the assistance information may be sent using a small data transmission (SDT). For example, the assistance information could be transmitted in an RRC message through dedicated control channel (DCCH). In this example, the assistance information may include information such as available RSRP, RSRQ, and SINR measurements for the cell and/or one or more beams. The one or more beams could be a set of beams associated with one or more satisfied conditions (for conditional reporting), or it could be the best N number of beams (where N is configured via RRC release or SIB). The assistance information may also include corresponding beam indices of the one or more beams.

In some alternative aspects, when the UE 101 is configured for conditional reporting (e.g. UE reports assistance information when a value of the measurement 206 is larger/smaller than a threshold value) the UE may send the assistance information using a new set of preambles/random access channel (RACH) occasions (ROs). Using the RRC release message 204, a mapping may be configured for subsets of the new set of preambles/ROs to different conditions. In some alternative aspects, the mapping may be configured by SIB. The UE 101 may be configured to report assistance information whenever a condition is met by sending corresponding preambles/ROs. The condition, for example, can be any one of the conditions previously described, such as a measurement (of the beam, cell, etc.) being greater than or less than a threshold value.

For example, a condition may be mapped to a subset of preambles/ROs that are associated with SSBs. In some aspects, when the condition is met by multiple SSBs, the UE 101 shall send preambles (according to the mapping) in all ROs associated with the multiple SSBs. As an example, suppose the condition is met by measurements of first and second SSBs, and the condition is not met by measurement of a third of SSB. The UE 101 may send preambles (according to the mapping) in ROs associated with the first and second SSBs. Since the ROs are associated with the SSBs that satisfy the condition, the base station 111 may know which SSBs the UE 101 is referring to. Additionally, the base station 111 may know which condition was satisfied based on the mapping from the preambles and ROs to the condition.

In some alternative aspects, when a condition is met by one or more SSBs, the UE 101 shall send preamble only in the RO associated with a SSB determined to have the best channel quality. For example, the condition is met by measurement of first and second SSBs. Based on the measurements, the first SSB is determined to have the best channel quality. The UE 101 would send preamble (according to the mapping) in the ROs associated with the first SSB.

In some additional alternative aspects, when the UE 101 is configured for conditional reporting, the assistance information may be sent using one or more designed sequences in a configured resource associated with the SSBs. A mapping from the one or more designed sequences to different conditions may be configured via RRC release or SIB. The UE 101 may only send the sequence when uplink is synchronized (e.g. after an uplink synchronization process has been performed). The uplink control information (UCI) and/or channel state information (CSI) may also be included in this sequence. As an example, the resource to send the sequence can be associated with an RO. In each reporting occasion, the UE 101 can send the sequence only after sending preamble and getting a random access response (RAR) with a timing advance (TA) adjustment. The sequence sent by the UE 101 may be determined by the mapping from the sequence to a satisfied condition. The base station 111 may know which condition was satisfied based on the mapping from the sequence(s) and the transmitting resource(s) to the conditions.

In some aspects, the base station 111 may adapt its transmission of SSBs based on the assistance information received from the UE 101 at 210. For example, based on the assistance information, the base station 111 may adapt the transmission of SSBs to have shorter periodicity and more beams. For example, the base station 111 may adapt SSBs 222 with 2 wide beams to SSBs 224 having 4 narrower beams and adapt to transmit SSBs 224 with a shorter periodicity upon receiving the assistance information. The SSBs 224 may be contained within their respective SMTC window 220b. Though the example of increasing the number of beams and shortening the periodicity is given, the base station 111 may choose to increase or decrease the number of beams, increase or decrease beam width, and lengthen or shorten SSB periodicity individually, among other applicable pattern parameters, based on needs of the UE and/or network.

In some aspects, the base station 111 receives assistance information from the UE 101 at 210 but does not adapt SSB transmission. This may be due to a determination by the base station 111 based on the assistance information that the SSB transmission is already optimized. By receiving assistance information to adapt SSB transmission without the UE 101 entering connected state, the base station 111 can save power by using more sparse reference signals during regular operation and only using more aggressive (i.e. higher energy consumption) transmission methods when needed. Since the UE 101 reports the assistance information while in RRC idle/inactive state, the UE 101 does not need to transition to RRC connected state, and therefore does not consume excessive energy to perform the reporting.

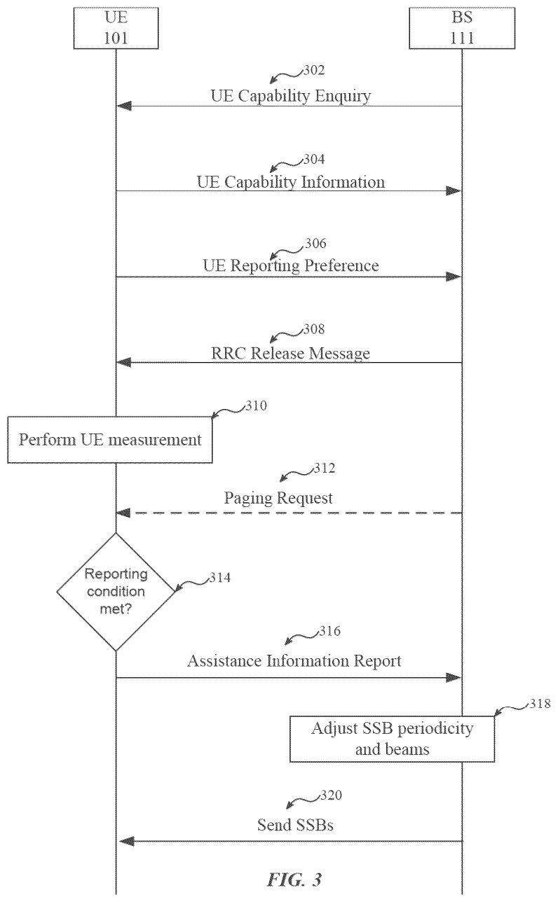

FIG. 3 is a schematic diagram illustrating signaling between a UE 101 and a base station 111 for adapting SSB transmission based on assistance information in accordance with some aspects of the disclosure. The base station 111 may send a UE Capability Enquiry 302 to the UE 101 while in an RRC connected state. In response, UE 101 sends UE Capability Information 304 to the base station 111. The UE Capability Information 304 may include a UE capability to report assistance information while in RRC idle/inactive. The UE Capability Information 304 may comprise a single bit indicating whether the UE 101 can report the assistance information when the UE 101 is in RRC idle/inactive state, or may comprise multiple bits for capability to report assistance information contents. For example, the multiple bits may comprise one or more bits indicating UE capability to report for SSB measurement, another one or more bits indicating UE capability to report for mobility status, etc.

If the UE 101 supports RRC idle/inactive assistance information reporting, the UE 101 may additionally send UE Reporting Preference 306 to the base station 111. The UE Reporting Preference 306 could include preference information such as if the UE 101 is willing to report, and how long to report. The willingness to report could include a first value indicating that the UE 101 is willing to report assistance information while in RRC idle/inactive, or a second value indicating that the UE 101 is not willing to report assistance information while in RRC idle/inactive. How long to report could include a time duration the UE 101 is willing to report after entering RRC idle/inactive mode. After the time duration is exceeded, if the UE 101 is still in RRC idle/inactive mode, the UE 101 ceases reporting.

In some aspects, the UE Reporting Preference 306 may be part of a dedicated uplink (UL) RRC message. In some aspects, the UE Reporting Preference 306 is included in UAI. The UE Reporting Preference 306 may be determined based on one or more factors, including a power state (e.g. low power, high power), a mobility (e.g. low or high speed mobility), and user preference.

The base station 111 may send an RRC Release message 308 to the UE 101. The RRC Release Message 308 may cause the UE 101 to enter RRC idle or RRC inactive state. Additionally, the RRC Release Message 308 may include information such as a UE measurement configuration to configure a UE measurement, and a UE assistance configuration to configure assistance information reporting for the UE. The UE measurement configuration may be based on the UE capability information and/or UE preference information. The UE assistance configuration may also be based on the UE capability information and/or UE preference information.

While in the RRC idle/inactive state, the UE 101 may receive further reconfiguration information included in SIB. The reconfiguration information could reconfigure the UE 101 to continue measurement and reporting after performing cell reselection (e.g. continue reporting assistance information on a neighboring cell). The reconfiguration information may include an indication whether the neighboring cell supports receiving assistance information reporting.

At 310, the UE 101 may perform UE measurement according to the received UE measurement configuration. In some aspects, the measurement may be a cell RSRP, RSRQ, or SINR measurement. In some alternative or additional aspects, the measurement may also be a beam RSRP, RSRQ, or SINR measurement for one or more beams. Each beam measurement may have a corresponding beam index. In one aspect, the beam measurement is for the best beam available. In other aspects, the beam measurements include a RSRP, RSRQ, or SINR value for the best N number of beams. The value for N could be configured by a base station via the RRC Release Message 308 or via SIB. The configured measurement may comprise measuring various combinations of the RSRP, RSRQ, and SINR values of the cell and/or beam(s) (e.g. each value individually, or any combination thereof).

In some aspects, optionally, the base station sends a paging request 312 to the UE. In response to the paging request, the UE reports a result of the UE measurement to the base station in Assistance Information Report 316. In one aspect, the paging request may be a paging record. The paging message may include a paging cause (e.g. a request for assistance information) to indicate that the UE 101 should report assistance information. The paging message may further indicate which measurements the UE 101 is to report. Some examples of measurements are cell measurements, beam measurements, or a subset of beam measurements. The subset of beams to be reported could be configured in RRC Release Message 308.

In some aspects, the paging request may be part of a group paging message. This could be accomplished via EPI. The EPI could trigger assistance information reporting for a group of UEs in RRC idle/inactive state. Because the network does not have to send multiple paging messages to different UEs, network efficiency is increased. In some aspects, DCI is sent to a plurality of UEs. The DCI may comprise an EPI. The paging message is then transmitted to the plurality of UEs. In some other aspects, the paging request may be a short message such as short message in DCI 1-0. This short message could trigger assistance information reporting.

In some aspects, the UE 101 may choose to ignore the paging request and not report assistance information. This decision could be made by the UE 101 based on a UE energy level (e.g. UE 101 doesn't report when in a low energy state) or based on a user preference.

In other aspects, the UE 101 may be configured for conditional reporting. After performing UE measurement at 310, the UE 101 may compare a result of the measurement with a threshold value at 314. Based on the comparison of the measurement result with the threshold value (e.g. greater than or less than the threshold value, the condition can be configured by UE assistance configuration) the reporting condition is met or not met.

When the UE 101 is configured for conditional reporting, the UE may be configured for multiple conditions. For example, the UE 101 could report when a cell SINR is greater than a threshold value and the UE 101 could also report when a cell RSRQ is less than a different threshold value. These reporting processes could be performed in parallel. Although a specific example is given, any possible combination of conditions could be used for conditional reporting.

If the reporting condition is met, UE 101 may report assistance information to the base station. If the condition is met at 314, the UE will send Assistance Information Report 316 to the base station 111. If the condition is not met at 314, the UE will not report assistance information and will continue to perform measurement at 310 periodically, repeating the process.

In further aspects, the UE 101 may be configured for periodical reporting. Periodic reporting, for example, could be accomplished using a timer. The timer may start when the UE 101 enters RRC idle or RRC inactive state, and the UE 101 may report assistance information every time the timer expires. After reporting the assistance information, the timer may be reset and the UE 101 will return to report assistance information when the timer expires again.

The Assistance Information Report 316 may include a result of the measurement performed at 310. For example, the Assistance Information Report 316 may include one or more cell RSRP, RSRQ, or SINR values and/or one or more beam RSRP, RSRQ, or SINR values. If the values are a beam value, they may also include an equal number of corresponding beam indexes. In some aspects, the beam values are included for the best N number of beams, which may be configured via the RRC Release Message 308 or via SIB. In some aspects, the Assistance Information Report 316 may also include a downlink (DL) bit error rate (BER) value.

In some aspects, the Assistance Information Report 316 may also indicate a presence or absence of the UE 101. The Assistance Information Report 316 may include a mobility status of the UE 101. The mobility status could include information indicating a number of cells the UE connects to in a configured duration or an indication on a level of mobility, such as low, medium, or high. The UE 101 is on a high mobility status, for example, when the UE 101 moves at an average speed greater than a predefined high mobility threshold. Similarly, the UE 101 is on a low or medium mobility status, for example, when the UE 101 moves respectively at an average speed below a low mobility threshold or between the high mobility threshold and the low mobility threshold. The Assistance Information Report 316 may also include a mapping from the SSB indexes to ROs and/or a mapping from the SSB indexes to resources to send new sequences.

The UE 101 may send in the Assistance Information Report 316 in several ways. In one aspect, the UE 101 may include the assistance information in an SDT message to the base station 111. The assistance information could be in the form of an RRC message included in the SDT message. The assistance information may include RSRP, RSRQ, and/or SINR measurements for the cell and/or beams. The beams may include beams associated with a condition (e.g. for conditional reporting), or the best N number of beams. The number N could be configured via RRC Release Message 308 and could be configured/reconfigured via SIB. The best beams may be based on results of the performed measurements (e.g. RSRP, RSRQ, SINR measurements).

In another aspect, the UE 101 may send the Assistance Information Report 316 using a new set of preambles in ROs. This method may be used when conditional reporting is configured. Using the UE assistance configuration from the RRC Release Message 308 or SIB, a mapping from different conditions to a plurality of sub-sets of preambles in ROs can be configured.

In some aspects, each sub-set of the plurality of sub-sets of preambles in ROs is mapped to a different condition. In one alternative, the UE 101 is configured to report the assistance information based on a condition. The preambles may be sent in all ROs whose associated SSB measurements satisfy the condition. For example, if the UE 101 is configured to evaluate the condition for first, second, and third SSBs. If the first and second SSBs satisfy the condition, but the third SSB does not satisfy the condition, the UE 101 would send preambles (according to the mapping) in ROs for the first and second SSBs. In another alternative, the preambles may be sent in only one RO whose associated SSB measurement satisfies the condition with a best channel quality. For example, if the UE 101 is configured to evaluate the condition for first, second, and third SSBs. If the first and second SSBs satisfy the condition, and the first SSB is determined to have a better channel quality, then the UE 101 would send preamble(s), according to the mapping, in the RO(s) associated with only the first SSB.

In one aspect, the UE 101 may include the assistance information in one or more designed sequences. The one or more designed sequences may be included in a configured resource associated with the SSB. This method may be used when conditional reporting is configured. Based on the conditional reporting, a mapping from different conditions to different designed sequence can be configured. The mapping can be included in the RRC Release Message 308 or SIB.

Each designed sequence may be mapped to a single condition. For example, if the UE 101 is configured for conditional reporting, and is configured to report when condition A, B, or C is met. Conditions A, B, and C may be respectively associated with first, second, and third sequence respectively. A designed sequence associated with a certain condition, for example, may be configured based on the relevant SSBs (e.g. the SSBs used in the measurement or determination of the certain condition).

In some aspects, the UE 101 may send the sequence only when UL is synchronized. The UCI and/or CSI may also be integrated in this sequence. In some aspects, the resource to send the sequence may be associated with an RO. The UE 101 may only send the sequence after sending preamble and receiving RAR with TA adjustment.

Based on the Assistance Information Report 316, the base station may adjust its transmission of SSB at 318. In some aspects, the adjustment is made based on assistance information included in the Assistance Information Report 316. The base station 111 may change the number of SSB beams, width of SSB beams, and periodicity of the SSB transmission based on the assistance information. In some aspects, based on the assistance information, the base station 111 may determine that no SSB adjustment is necessary at 318. At 320, the base station will transmit SSBs to the UE 101 according to the SSB adjustment or lack thereof.

In some aspects, after sending Assistance Information Report 316, the UE 101 may postpone cell reselection for a duration in order to wait for the network to complete adaptation of SSB transmission at 318 based on the assistance information. This duration may be configured by an RRC message (e.g. RRC release) or may be pre-configured and included in SIB.

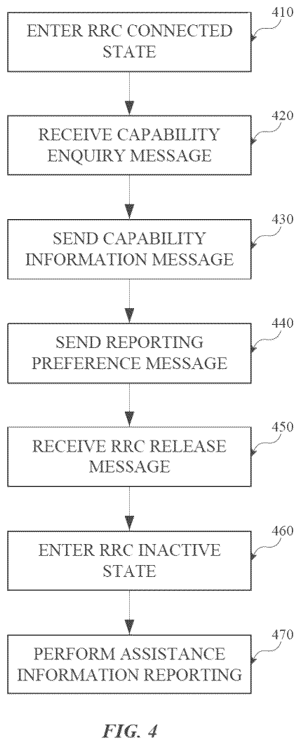

FIG. 4 is a flow diagram depicting a method for reporting assistance information. At 410 a UE may enter an RRC connected state. In some aspects, the UE may be UE 101 as previously described.

At act 420, the UE receives a UE capability enquiry message including a request for UE capability to report assistance information in RRC idle/inactive. The UE may respond with UE capability information at 430. The UE capability information may include an indication of whether UE can report in RRC idle/inactive. At act 440, the UE may indicate a reporting preference (willingness to report, how long to report) to the base station in a reporting preference message. In some aspects, the reporting preference is included in a UAI message.

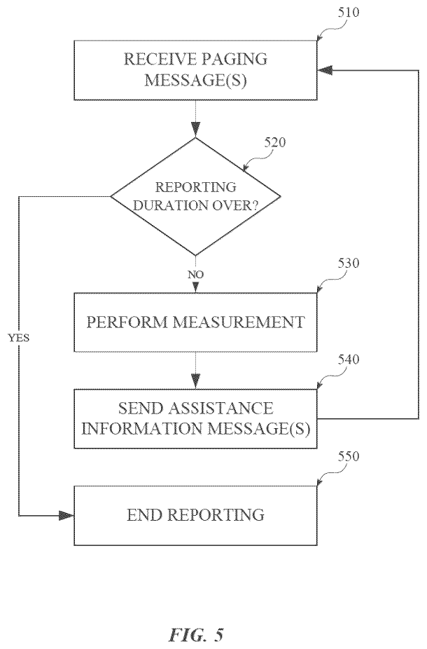

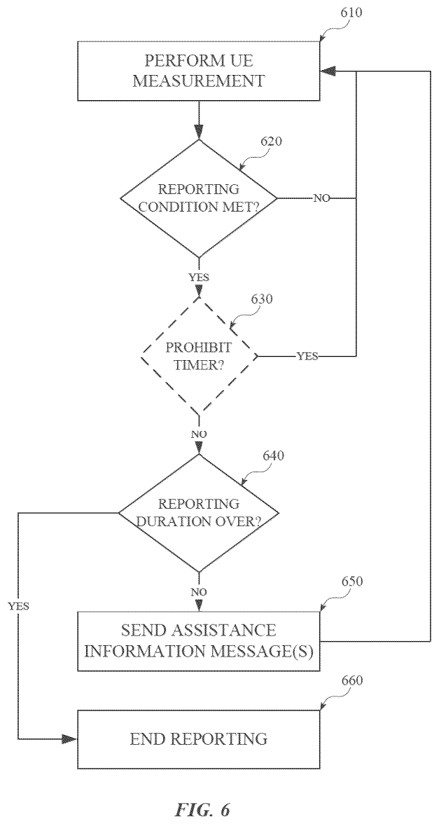

The UE receives RRC release message at 450, which contains a UE assistance configuration to configure assistance information reporting and a UE measurement configuration to configure UE measurement. The RRC release message causes the UE to enter an RRC inactive or RRC idle state at 460. The UE then performs assistance information reporting at 470 in accordance with one of FIGS. 5, 6, or 7.

FIG. 5 illustrates a logic flow for a UE configured to report assistance information. FIG. 5 may represent step 470 of FIG. 4. In some aspects, the UE is UE

At act 510, the UE receives a paging message requesting assistance information. At act 520, the UE checks if a reporting duration is over. This may be accomplished by comparing a timer to a threshold value. The timer may be started when the UE enters RRC inactive/idle at act 460. The threshold value may be a duration to report assistance information, which may be included in the UE assistance configuration. If the timer is less than the threshold value, the UE may perform measurement at act 530 according to the measurement configuration.

The UE may send assistance information including a result of the measurement to the base station at act 540. After reporting the assistance information, the UE may return to act 510 and await another paging message. If the timer is not less than the threshold value (i.e. if the reporting duration is over), the UE may end assistance information reporting at 550.

FIG. 6 illustrates a logic flow for a UE configured to report assistance information. FIG. 6 may represent step 470 of FIG. 4. In some aspects, the UE is UE 101 as previously described.

The UE may perform measurement at act 610 according to the measurement configuration. The UE may then check if a reporting condition is met at act 620. The reporting condition may include comparing the measurement value to a threshold value (e.g. greater than or less than the threshold value, configured by UE assistance configuration), as previously described. If the reporting condition is not met, the UE will return to perform measurement at act 610.

In some aspects, if the reporting condition is met, the UE may check if a prohibit timer is running at act 630. The prohibit timer may prevent the UE from reporting too frequently in order to save energy. The prohibit timer may be started at act 650 and may specify a minimum time between assistance information reports. If the prohibit timer is still running, the UE may return to perform measurement at act 610. If the prohibit timer has expired, the UE may continue to act 640. In some aspects, the prohibit timer is not configured and act 630 is skipped.

At act 640, the UE checks if a reporting duration is over. This may be accomplished by comparing a timer to a threshold value. The timer may be started when the UE enters RRC inactive/idle at act 460. The threshold value may be a duration to report assistance information, which may be included in the UE assistance configuration. If the timer is less than the threshold value, the UE may send assistance information including a result of the measurement to the base station at act 650. If the timer is not less than the threshold value, the UE may end assistance information reporting at act 660.

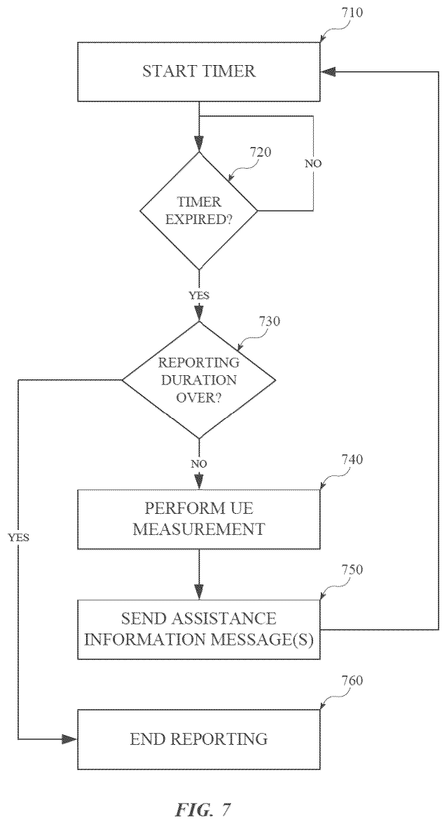

FIG. 7 illustrates a logic flow for a UE configured to report assistance information. FIG. 7 may represent step 470 of FIG. 4. In some aspects, the UE may be UE 101 as previously described.

In some aspects, the UE may start at act 740, however, for the purpose of simplification, the logic flow will be described as starting from act 710. The UE may start a first timer at act 710. The first timer may be used to implement periodic reporting. The first timer may be assigned an initial value, which corresponds to a time between assistance information reports. The UE may check if the first timer is expired at 720. If the first timer is not expired, the UE will wait at act 720 until the first timer has expired. Once the first timer expires, the UE prepares to send an assistance information report, as detailed by the following steps.

Once the first timer has expired, the UE will check if a reporting duration is over at act 730. This may be accomplished by comparing a second timer to a threshold value. The second timer may be started when the UE enters RRC inactive/idle. The threshold value may be a duration to report assistance information, which may be included in the UE assistance configuration. If the second timer is less than the threshold value, the UE may perform measurement at act 740 according to the measurement configuration. The UE may then send assistance information including a result of the measurement to the base station at act 750. If the second timer is not less than the threshold value, the UE may end assistance information reporting at act 760.

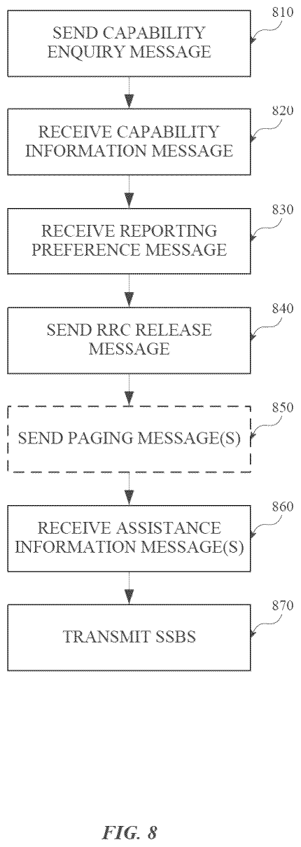

FIG. 8 is a flow diagram depicting a method for reporting assistance information. At act 810, a base station sends a capability enquiry message to a UE. In some aspects, the UE is the UE 101 as previously described. In some aspects the base station is base station 111 as previously described.

In response, the base station receives a capability information message at act 820 comprising UE capability information. The UE capability information may be the capability information previously described. The base station may receive a reporting preference message at act 830, comprising UE preference information, which may be the UE preference information as previously described.

At act 840, the base station may send an RRC release message to the UE to cause the UE to enter an RRC inactive or RRC idle state. The RRC release message may comprise a UE assistance configuration to configure assistance information reporting, and a UE measurement configuration to configure UE measurement.

At act 850, the base station sends a paging message to the UE requesting assistance information. The UE responds, and at act 860, the base station receives an assistance information message comprising the assistance information.

In another aspect, the base station receives assistance information message at act 860 without sending a paging message at act 850. This may be a result of the UE being configured for periodic or conditional assistance information reporting, which requires no paging message from the base station to trigger the assistance information report.

At act 870, the base station may transmit SSBs to the UE. The SSBs may be adapted (e.g. SSB periodicity changed or SSB number of beams changed) based on the assistance information received at act 860.

After act 870 is completed, the process may return to act 850 or 860, depending on if paging is configured. Assistance information will continue to be reported and SSBs will continue to be adapted/transmitted until assistance information reported is ended (e.g. when the UE's configured reporting duration is over).

In aspects, the CN 120 can be a 5GC (referred to as “5GC 120” or the like), and the RAN 110 can be connected with the CN 120 via two parts, a Next Generation (NG) user plane (NG-U) interface 114, which carries traffic data between the RAN nodes and a User Plane Function (UPF), and the S1 control plane (NG-C) interface 115, which is a signaling interface between the RAN nodes and Access and Mobility Management Functions (AMFs).

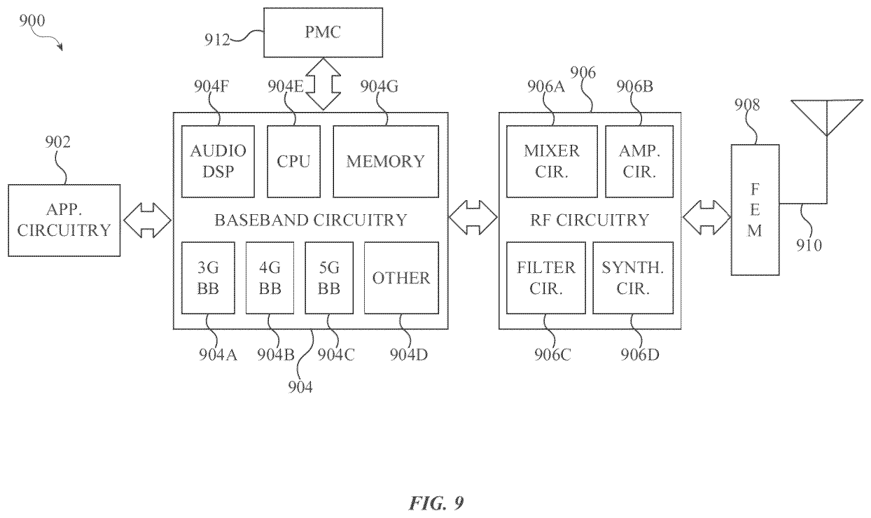

FIG. 9 is a diagram illustrating example components of a device 900 that can be employed in accordance with some aspects of the present disclosure. In some aspects, the device 900 can include application circuitry 902, baseband circuitry 904, Radio Frequency (RF) circuitry 906, front-end module (FEM) circuitry 908, one or more antennas 910, and power management circuitry (PMC) 912 coupled together at least as shown. The components of the illustrated device 900 can be included in a UE or a RAN node such as the UE 101 or the base station 111 as described, for example, with reference to FIGS. 1-3 and throughout the present disclosure. The UE 101 may be configured to perform assistance information reporting, as described throughout the present disclosure. In some implementations, the device 900 can include fewer elements (e.g., a RAN node may not utilize application circuitry 902 and instead include a processor/controller to process IP data received from a CN, which may be a 5GC or an Evolved Packet Core (EPC)). In some implementations, the device 900 can include additional elements such as, for example, memory/storage, display, camera, sensor (including one or more temperature sensors, such as a single temperature sensor, a plurality of temperature sensors at different locations in device 900, etc.), or input/output (I/O) interface. In other implementations, the components described below can be included in more than one device (e.g., said circuitries can be separately included in more than one device for Cloud-RAN (C-RAN) implementations).

The application circuitry 902 can include one or more application processors. For example, the application circuitry 902 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 900. In some implementations, processors of application circuitry 902 can process IP data packets received from an EPC.

The baseband circuitry 904 can include circuitry such as, but not limited to, one or more single-core or multi-core processors. The baseband circuitry 904 can include one or more baseband processors or control logic to process baseband signals received from a receive signal path of the RF circuitry 906 and to generate baseband signals for a transmit signal path of the RF circuitry 906. Baseband circuitry 904 can interface with the application circuitry 902 for generation and processing of the baseband signals and for controlling operations of the RF circuitry 906. For example, in some implementations, the baseband circuitry 904 can include a 3G baseband processor 904A, a 4G baseband processor 904B, a 5G baseband processor 904C, or other baseband processor(s) 904D for other existing generations, generations in development or to be developed in the future (e.g., 2G, 6G, etc.).

The baseband circuitry 904 (e.g., one or more of baseband processors 904A-D) can handle various radio control functions that enable communication with one or more radio networks via the RF circuitry 906. In other implementations, some or all of the functionality of baseband processors 904A-D can be included in modules stored in the memory 904G and executed via a Central Processing Unit (CPU) 904E. The radio control functions can include, but are not limited to, signal modulation/demodulation, encoding/decoding, radio frequency shifting, etc. In some implementations, the baseband circuitry 904 can include one or more audio digital signal processor(s) (DSP) 904F.

RF circuitry 906 can enable communication with wireless networks using modulated electromagnetic radiation through a non-solid medium. In various implementations, the RF circuitry 906 can include switches, filters, amplifiers, etc. to facilitate the communication with the wireless network. RF circuitry 906 can include a receive signal path which can include circuitry to down-convert RF signals received from the FEM circuitry 908 and provide baseband signals to the baseband circuitry 904. RF circuitry 906 can also include a transmit signal path which can include circuitry to up-convert baseband signals provided by the baseband circuitry 904 and provide RF output signals to the FEM circuitry 908 for transmission.

In some implementations, the receive signal path of the RF circuitry 906 can include mixer circuitry 906A, amplifier circuitry 906B and filter circuitry 906C. In some implementations, the transmit signal path of the RF circuitry 906 can include filter circuitry 906C and mixer circuitry 906A. RF circuitry 906 can also include synthesizer circuitry 906D for synthesizing a frequency for use by the mixer circuitry 906A of the receive signal path and the transmit signal path.

If there is no data traffic activity for an extended period of time, then the device 900 can transition off to an RRC_Idle state, where it disconnects from the network and does not perform operations such as channel quality feedback, handover, etc. The device 900 goes into a very low power state and it performs paging where again it periodically wakes up to listen to the network and then powers down again. The device 900 may not receive data in this state; in order to receive data, it can transition back to RRC_Connected state.

An additional power saving mode can allow a device to be unavailable to the network for periods longer than a paging interval (ranging from seconds to a few hours). During this time, the device is totally unreachable to the network and can power down completely. Any data sent during this time incurs a large delay and it is assumed the delay is acceptable.

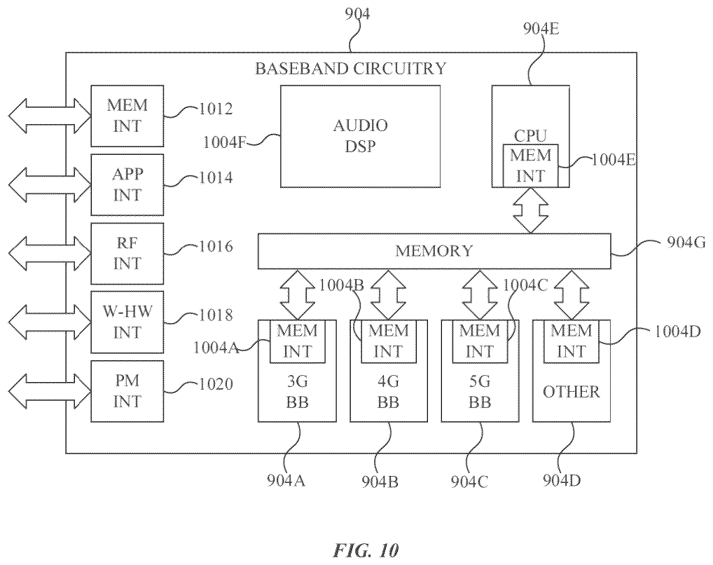

FIG. 10 illustrates a diagram illustrating example interfaces of baseband circuitry that can be employed in accordance with some aspects. As discussed above, the baseband circuitry 904 of FIG. 9 can comprise processors 904A-904E and a memory 904G utilized by said processors. Each of the processors 904A-904E can include a memory interface, 1004A-1004E, respectively, to send/receive data to/from the memory 904G.

The baseband circuitry 904 can further include one or more interfaces to communicatively couple to other circuitries/devices, such as a memory interface 1012 (e.g., an interface to send/receive data to/from memory external to the baseband circuitry 904), an application circuitry interface 1014 (e.g., an interface to send/receive data to/from the application circuitry 902 of FIG. 9), an RF circuitry interface 1016 (e.g., an interface to send/receive data to/from RF circuitry 906 of FIG. 9), a wireless hardware connectivity interface 1018 (e.g., an interface to send/receive data to/from Near Field Communication (NFC) components, Bluetooth® components (e.g., Bluetooth® Low Energy), Wi-Fi® components, and other communication components), and a power management interface 1020 (e.g., an interface to send/receive power or control signals to/from the PMC 912).

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

Example 1 is an apparatus for a user equipment (UE) comprising one or more processors. The one or more processors are configured to: receive a radio resource control (RRC) release message to terminate or suspend an RRC connected state with a base station, the RRC release message including a UE measurement configuration to configure a UE measurement and a UE assistance configuration to configure assistance information reporting, enter an RRC idle or inactive state, perform the UE measurement, and transmit assistance information during the RRC idle or inactive state for the assistance information reporting, wherein the assistance information comprises a value of the performed configured measurement.

Example 2 comprises the subject matter of any variation of example 1, wherein the one or more processors are further configured to start a reporting timer, wherein the assistance information is reported if a value of the reporting timer is less than a timer threshold value, and wherein the UE assistance configuration indicates the timer threshold value.

Example 3 comprises the subject matter of any variation of example 1, wherein the one or more processors are further configured to: receive one or more synchronization signal blocks (SSBs) from the base station, and perform an SSB measurement with the one or more SSBs received from the base station, wherein a pattern of the received SSBs is determined based on the assistance information.

Example 4 comprises the subject matter of any variation of example 3, wherein the pattern of the received SSBs includes a periodicity and an amount of allocated beams.

Example 5 comprises the subject matter of any variation of example 1, wherein, during the RRC connected state with the base station, the one or more processors are configured to: receive a capability enquiry message, and transmit, in response to the capability enquiry message, UE capability information indicating UE capability of reporting assistance information, wherein the UE assistance configuration is based on the UE capability information.

Example 6 comprises the subject matter of any variation of example 5, wherein the UE capability information is a single bit indicating whether the UE is

Example 7 comprises the subject matter of any variation of example 5, wherein the UE capability information comprises a group of bits respectively indicating whether the UE is capable of reporting a group of assistance information contents including beam measurements and mobility status.

Example 8 comprises the subject matter of any variation of example 5, wherein, during the RRC connected state with the base station, the one or more processors are further configured to transmit, via a dedicated uplink RRC message, UE assistance information (UAI), the UAI including reporting preference information indicating a UE preference on reporting, wherein the UE assistance configuration is based on the reporting preference information.

Example 9 comprises the subject matter of any variation of example 1, wherein the UE is scheduled to report the assistance information periodically according to a timer.

Example 10 comprises the subject matter of any variation of example 1, wherein the UE reports the assistance information via a small data transmission (SDT) message transmitted in an RRC message on dedicated control channel (DCCH).

Example 11 comprises the subject matter of any variation of example 10, wherein the assistance information comprises measurement results for one or more beams and corresponding beam indices of the one or more beams, and wherein the one or more beams are associated with one or more satisfied conditions or are the best N number of beams

Example 12 comprises the subject matter of any variation of example 1, wherein the UE reports the assistance information via a preamble/random access channel (RACH) occasion (RO) based on the UE assistance configuration.

Example 13 comprises the subject matter of any variation of example 12, wherein the assistance information reporting further comprises: determining that a first synchronization signal block (SSB) measurement on a first SSB satisfies a condition, and sending a first preamble in a first RO in response to the first SSB measurement satisfying the condition, wherein the first preamble and first RO are indicated in a mapping to the condition, and wherein the mapping is included in the RRC release message.

Example 14 comprises the subject matter of any variation of example 13, wherein the assistance information reporting further comprises: determining that a second SSB measurement on a second SSB satisfies the condition, determining that the first SSB measurement satisfies the condition with a better channel quality than the second SSB measurement, and sending only the first preamble in the first RO in response to the first SSB measurement satisfying the condition and having the better channel quality.

Example 15 comprises the subject matter of any variation of example 1, wherein the UE reports the assistance information in a sequence based on the UE assistance configuration.

Example 16 comprises the subject matter of any variation of example 15, wherein reporting the assistance information is performed after performing an uplink synchronization process.

Example 17 comprises the subject matter of any variation of example 15, wherein the sequence further indicates channel state information (CSI) or uplink control information (UCI).

Example 18 comprises the subject matter of any variation of example 15, wherein a resource associated with the sequence is associated with a random access channel (RACH) occasion (RO).

Example 19 comprises the subject matter of any variation of example 15, wherein the sequence is sent after sending a preamble and receiving a random access response (RAR) with a timing advance (TA) adjustment.

Example 20 comprises the subject matter of any variation of example 1, wherein the one or more processors are further configured to: start a reporting timer, wherein the assistance information is reported if a value of the reporting timer is less than a timer threshold value, and wherein the timer threshold value is indicated in a system information block (SIB).

Example 21 comprises the subject matter of any variation of example 1, wherein the UE is scheduled to report the assistance information based on a value of the UE measurement relative to a threshold.

Example 22 comprises the subject matter of any variation of example 1, wherein the UE measurement is a reference signal received power (RSRP) measurement, a reference signal received quality (RSRQ) measurement, or a signal to interference and noise ratio (SINR) measurement.

Example 23 comprises the subject matter of any variation of example 22, wherein the UE measurement is associated with a cell.

Example 24 comprises the subject matter of any variation of example 22, wherein the UE measurement is associated with one or more beams.

Example 25 comprises the subject matter of any variation of example 24, wherein a number of beams associated with the UE measurement is configurable, and wherein the number of beams is configured by the RRC release message.

Example 26 comprises the subject matter of any variation of example 24, wherein the assistance information further comprises one or more corresponding beam indices for the one or more beams.

Example 27 comprises the subject matter of any variation of example 21, wherein the one or more processors are further configured to configure a prohibit timer, wherein the prohibit timer specifies a minimum time interval between the assistance information report and a next assistance information report.

Example 28 comprises the subject matter of any variation of example 1, wherein the one or more processors are further configured to report the assistance information in response to a paging message.

Example 29 comprises the subject matter of any variation of example 1, wherein the one or more processors are further configured to: receive a paging message including a request to report the assistance information, and ignore the paging message based on an energy level of the UE.

Example 30 comprises the subject matter of any variation of example 1, wherein the one or more processors are further configured to: receive a paging message including a request to report the assistance information, and ignore the paging message based on a preference of the UE.

Example 31 comprises the subject matter of any variation of example 1, wherein the one or more processors are further configured to receive a system information block (SIB) including an additional UE assistance configuration, wherein the assistance information reporting is further configured by the additional UE assistance configuration.

Example 32 comprises the subject matter of any variation of example 31, wherein the RRC release message is received from a serving cell, and wherein the assistance information is reported to a neighbor cell.

Example 33 comprises the subject matter of any variation of example 32, wherein the SIB indicates that the neighbor cell supports receiving the assistance information.

Example 34 comprises the subject matter of any variation of example 1, wherein the one or more processors are further configured to postpone a cell reselection procedure for a first duration after reporting the assistance information.

Example 35 comprises the subject matter of any variation of example 34, wherein the first duration is indicated by the RRC release message.

Example 36 comprises the subject matter of any variation of example 34, wherein the first duration is indicated by a system information block (SIB).

Example 37 is an apparatus for a base station comprising one or more processors. The one or more processors are configured to: transmit a radio resource control (RRC) release message to terminate or suspend an RRC connected state with a user equipment (UE), the RRC release message including a UE measurement configuration to configure a UE measurement and a UE assistance configuration to configure assistance information reporting, receive an assistance information message indicating assistance information during an RRC idle or inactive state, and transmit one or more synchronization signal blocks (SSBs) with a pattern based on the assistance information.

Example 38 comprises the subject matter of any variation of example 37, wherein the pattern of the SSBs comprises at least one of a periodicity of the SSBs based on the assistance information or a number of beams of the SSBs based on the assistance information.

Example 39 comprises the subject matter of any variation of example 37, wherein the one or more processors are further configured to: transmit a capability enquiry message, receive capability information indicating UE capability of reporting assistance information, and receive UE assistance information (UAI), the UAI including reporting preference information indicating a UE reporting preference for reporting, wherein the UE assistance configuration is based on the capability information and the reporting preference information.

Example 40 comprises the subject matter of any variation of example 37, wherein the one or more processors are further configured to transmit a paging message, wherein the assistance information message is received in response to the paging message.

Example 41 comprises the subject matter of any variation of example 40, wherein the paging message comprises a paging cause, and wherein the paging cause indicates that the paging message is a request for assistance information.

Example 42 comprises the subject matter of any variation of example 40, wherein the paging message comprises reporting configuration information indicating one or more measurement types to be included in the assistance information.

Example 43 comprises the subject matter of any variation of example 42, wherein the one or more measurements comprises one or more beam measurements, wherein one or more beams associated with the one or more beam measurements are configured by the RRC release message.

Example 44 comprises the subject matter of any variation of example 40, wherein the one or more processors are further configured to: send a downlink control information (DCI) message to a plurality of UEs before transmitting the paging message, the DCI comprising an early paging indication (EPI), wherein the paging message is transmitted to the plurality of UEs.

Example 45 comprises the subject matter of any variation of example 40, wherein the paging message is transmitted as part of a short message in a downlink control information (DCI) format 1-0.

Example 46 is a method to be performed by a user equipment (UE), comprising: receiving a radio resource control (RRC) release message to terminal or suspend an RRC connected state with a base station, the RRC release message including a UE measurement configuration to configure a UE measurement and a UE assistance configuration to configure assistance information reporting, entering an RRC idle or inactive state, performing the configured UE measurement, and based on the configured assistance information reporting, reporting assistance information during the RRC idle or inactive state, wherein the assistance information comprises a value of the performed configured measurement.

Example 47 comprises the subject matter of any variation of example 46, the method further comprising: starting a reporting timer, wherein the assistance information is reported if a value of the reporting timer is less than a timer threshold value, and wherein the UE assistance configuration indicates the timer threshold value.

Example 48 comprises the subject matter of any variation of example 46, wherein the UE is scheduled to report the assistance information based on a value of the UE measurement relative to a threshold.

Example 49 comprises the subject matter of any variation of example 48, wherein the UE measurement is a reference signal received power (RSRP) measurement, a reference signal received quality (RSRQ) measurement, or a signal to interference and noise ratio (SINR) measurement.

Example 50 comprises the subject matter of any variation of example 49, wherein the UE measurement is associated with a cell.

Example 51 comprises the subject matter of any variation of example 49, wherein the UE measurement is associated with one or more beams.

Example 52 comprises the subject matter of any variation of example 51, wherein a number of beams associated with the UE measurement is configurable.

Example 53 comprises the subject matter of any variation of example 48, the method further comprising: configuring a prohibit timer, wherein the prohibit timer specifies a minimum time interval between the assistance information report and a next assistance information report.

Example 54 comprises the subject matter of any variation of example 46, the method further comprising: receiving a paging message, wherein the assistance information is reported in response to the paging message.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given or particular application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A baseband processor configured to, when executing instructions stored in a memory, perform operations comprising:
receiving a radio resource control (RRC) release message to terminate or suspend an RRC connected state with a base station, the RRC release message including a user equipment (UE) measurement configuration to configure a UE measurement and a UE assistance configuration to configure assistance information reporting;
entering an RRC idle or inactive state in response to receiving the RRC release message;
performing the UE measurement based on the UE measurement configuration; and
providing, to a radio frequency (RF) interface for transmission, assistance information during the RRC idle or inactive state based on the UE assistance configuration, wherein the assistance information comprises a value of the performed measurement.

2. The baseband processor of claim 1, wherein the operations further comprise:
receiving one or more synchronization signal blocks (SSBs) from the base station; and
performing an SSB measurement with the one or more SSBs received from the base station, wherein a pattern of the received SSBs is determined based on the assistance information.

3. The baseband processor of claim 1, wherein, during the RRC connected state with the base station, the the operations further comprise:
receiving a capability enquiry message; and
providing, in response to the capability enquiry message, UE capability information indicating UE capability of reporting assistance information;
wherein the UE assistance configuration is based on the UE capability information.

4. (canceled)

5. (canceled)

6. The baseband processor of claim 1, wherein the UE is scheduled to report the assistance information periodically according to a timer.

7. The baseband processor of claim 1, wherein the operations further comprise providing the assistance information via a small data transmission (SDT) message transmitted in an RRC message on a dedicated control channel (DCCH);
wherein the assistance information comprises measurement results for one or more beams and corresponding beam indices of the one or more beams; and
wherein the one or more beams are associated with one or more satisfied conditions or are the best N number of beams.

8. (canceled)

9. The baseband processor of claim 1, wherein the operations further comprise providing the assistance information via a preamble/random access channel (RACH) occasion (RO) based on the UE assistance configuration; and
wherein the assistance information reporting further comprises:
determining that a first synchronization signal block (SSB) measurement on a first SSB satisfies a condition; and
sending a first preamble in a first RO in response to the first SSB measurement satisfying the condition;
wherein the first preamble and first RO are indicated in a mapping to the condition; and
wherein the mapping is included in the RRC release message.

10. (canceled)

11. (canceled)

12. The baseband processor of claim 1, wherein the operations further comprise providing the assistance information in a sequence based on the UE assistance configuration, wherein a resource associated with the sequence is associated with a random access channel (RACH) occasion (RO).

13. (canceled)

14. The baseband processor of claim 1, wherein the operations further comprise:
starting a reporting timer; and
reporting the assistance information in response to a value of the reporting timer being less than a timer threshold value indicated in a system information block (SIB).

15. The baseband processor of claim 1, wherein the UE is scheduled to report the assistance information based on a value of the UE measurement relative to a threshold, and wherein the UE measurement is one of: a reference signal received power (RSRP) measurement, a reference signal received quality (RSRQ) measurement, or a signal to interference and noise ratio (SINR) measurement.

16. The baseband processor of claim 15, wherein:
the UE measurement is associated with a cell; or
the UE measurement is associated with one or more beams, wherein a number of the one or more beams associated with the UE measurement is configured by the RRC release message.

17. (canceled)

18. The baseband processor of claim 15, wherein the operations further comprise:
configuring a prohibit timer, wherein the prohibit timer specifies a minimum time interval between the assistance information report and a next assistance information report.

19. The baseband processor of claim 1, wherein the operations further comprise:
receiving a system information block (SIB) including an additional UE assistance configuration, wherein the assistance information reporting is further configured by the additional UE assistance configuration.

20. (canceled)

21. The baseband processor of claim 1, wherein the operations further comprise:
postponing a cell reselection procedure for a first duration after reporting the assistance information.

22. An apparatus for a base station, comprising
radio frequency (RF) circuitry;
a memory; and
one or more processors configured to execute instructions stored in the memory to:
transmit, via the RF circuitry, a radio resource control (RRC) release message to terminate or suspend an RRC connected state with a user equipment (UE), the RRC release message including a UE measurement configuration to configure a UE measurement and a UE assistance configuration to configure assistance information reporting;
receive an assistance information message indicating assistance information during an RRC idle or inactive state; and
transmit, via the RF circuitry, one or more synchronization signal blocks (SSBs) with a pattern based on the assistance information.

23. The apparatus of claim 22, wherein the pattern of the SSBs comprises at least one of a periodicity of the SSBs based on the assistance information or a number of beams of the SSBs based on the assistance information.

24. The apparatus of claim 22, wherein the one or more processors are further configured to:
transmit, via the RF circuitry, a capability enquiry message;
receive capability information indicating UE capability of reporting assistance information; and
receive UE assistance information (UAI), the UAI including reporting preference information indicating a UE reporting preference for reporting;
wherein the UE assistance configuration is based on the capability information and the reporting preference information.

25. The apparatus of claim 22, wherein the one or more processors are further configured to:
transmit, via the RF circuitry, a paging message, wherein the assistance information message is received in response to the paging message; and
send a downlink control information (DCI) message to a plurality of UEs before transmitting the paging message, the DCI comprising an early paging indication (EPI);
wherein the paging message is transmitted to the plurality of UEs.

26. (canceled)

27. (canceled)

28. (canceled)

29. (canceled)

30. (canceled)

31. A method to be performed by a user equipment (UE), comprising:
receiving a radio resource control (RRC) release message to terminal or suspend an RRC connected state with a base station, the RRC release message including a UE measurement configuration to configure a UE measurement and a UE assistance configuration to configure assistance information reporting;
entering an RRC idle or inactive state in response to receiving the RRC release message;
performing the configured UE measurement; and
based on the configured assistance information reporting, reporting assistance information during the RRC idle or inactive state, wherein the assistance information comprises a value of the performed configured measurement.

32. The method of claim 31, further comprising:
starting a reporting timer;
wherein the assistance information is reported if a value of the reporting timer is less than a timer threshold value, and wherein the UE assistance configuration indicates the timer threshold value.

33. (canceled)

34. The method of claim 31, further comprising:
receiving a paging message including a request to report the assistance information; and
ignoring the paging message based on an energy level of the UE or based on a preference of the UE.
